(19) United States
(12) Patent Application Publication
(10) Pub. No.: US 2004/0223587 A1
(43) Pub. Date: Nov. 11, 2004

(54) Radiographic apparatus

(76) Inventor: Osamu Tsujii, Tochigi (JP)

Correspondence Address: MORGAN & FINNEGAN, L.L.P., 3 WORLD FINANCIAL CENTER, NEW YORK, NY, 10281-2101, US

(21) Appl. No.: 10/829,911

(22) Filed: Apr. 22, 2004

(30) Foreign Application Priority Data
Apr. 24, 2003 (JP) 2003-120504

(51) Int. Cl. G01T 1/24; G01J 1/00

(52) U.S. Cl. 378/97

(57) ABSTRACT

In a radiographic apparatus comprising: a first photoelectric converter which converts incident radiation to an electric signal and acquires image data; and a second photoelectric converter formed on the same substrate as that of the first photoelectric converter, which converts incident radiation to an electric signal, a time constant of the first photoelectric converter is set larger than a time constant of the second photoelectric converter.

### FIELD OF THE INVENTION

The present invention relates to a radiographic apparatus which is applicable to an image sensing apparatus, generating image data by converting incident radiation to an electric signal using an image sensor, while detecting a dose of incident radiation and controlling exposure of the radiation using an automatic x-ray exposure controller (AEC). More particularly, the present invention relates to a technique of specifying a time constant (response speed) of a converter for generating image data and a time constant (response speed) of a converter for measuring and controlling a dose of incident radiation.

### BACKGROUND OF THE INVENTION

Normally, a conventional radiographic apparatus comprises a radiation detector for image sensing which two-dimensionally detects radiation transmitted through a test body such as a human body and generates an image, and an automatic x-ray exposure controller (AEC) which controls exposure of radiation irradiated by a radiation source.

An image sensing radiation detector of this type generally comprises pixels configured with MIS (Metal-Insulator-Semiconductor) photoelectric converters and TFT (Thin Film Transistor) switches arranged in a matrix form, and includes phosphor arranged on the radiation incident plane for converting radiation to visible light.

FIG. 15 is an equivalent circuit diagram of a conventional image sensing radiation detector. FIG. 16 is a plan view of the image sensing radiation detector shown in FIG. 15.

Referring to FIGS. 15 and 16, numeral 1008 denotes a semiconductor converter such as a photoelectric converter, and numeral 1007 denotes a TFT switch, both of which constitute a pixel. Note that although 4×4 pixels are shown in the pixel area herein, in reality, for instance 2000×2000 pixels are arranged on an insulated substrate.

The gate electrode of the TFT 1007 is connected to a common gate wire 1001, which is connected to a gate driver 1002 controlling ON/OFF of the TFT. The source or drain electrode of each TFT 1007 is connected to a common signal wire 1003, which is connected to an amplifier IC 1004. Further, as shown in FIGS. 15 and 16, a bias wire 1005 for driving the photoelectric converters is connected to a common electrode driver 1006.

Radiation irradiated to a test body is attenuated as it transmits through the test body, and converted to visible light on the phosphor layer. The visible light is incident on the photoelectric converter 1008 and converted to electric charge. The electric charge is transferred to the signal wire 1003 through the TFT 1007 in accordance with a gate driving pulse applied by the gate driver 1002, and outputted to external through the amplifier IC 1004. Thereafter, the electric charge generated by the photoelectric converter 1008 but has not been transferred is removed through the photoelectric converter driving bias wire 1005. This operation is called refresh.

FIG. 17 is a schematic cross sectional view taken along a line D-D′ in FIG. 16, and shows a layer construction of one-pixel area configured with the MIS photoelectric converter 1008 and TFT switch 1007. Shown herein is an example in which the MIS photoelectric converter 1008 and TFT switch 1007 are formed simultaneously.

The MIS photoelectric converter 1008 is constructed with a first conductive layer (lower electrode) 1101, a first insulating layer 1102, a first semiconductor layer 1103, an ohmic contact layer 1105, a second conductive layer (bias wire) 1106, and a transparent electrode 1113 (e.g., ITO). The lower electrode is connected to the source or drain electrode of the TFT 1007. The TFT 1007 comprises the first conductive layer 1101 (gate electrode layer), first insulating layer 1102 (gate insulating layer), first semiconductor layer 1103, ohmic contact layer 1105, and second conductive layer 1106 (source and drain electrode). Respective gate wires are connected to the electrode layer where gate electrodes of the TFT 1007 are formed, and signal wires are connected to the layer where the source and drain electrodes are formed. On top of the construction of the aforementioned MIS photoelectric converter 1008 and TFT 1007, a protection layer 1118 formed with, e.g., SiN and an organic film, and phosphor 1119 converting radiation to visible light are arranged.

Furthermore, an image sensing radiation detector employing the combination of a radiation direct conversion material conventionally typified by a-Se, storage capacitors, and TFT switches has come into practical use.

Next, a description is provided on the automatic x-ray exposure controller (AEC) which controls exposure of radiation irradiated by an X-ray source in a radiographic apparatus.

In a radiographic apparatus having two-dimensionally arranged sensors, generally it is necessary to adjust (AEC control) the dose of incident radiation for each test body or for each image sensing. Conventionally, an AEC controlling sensor is provided separately from the image sensing radiation detector. Plural thin AEC sensors, whose radiation attenuation is about 5%, are arranged on the front surface of the image sensing radiation detector. Based on the output of these AEC sensors, the radiation is stopped, thereby obtaining an appropriate radiation dose for imaging. The AEC sensor employed herein is the type that directly detects radiation as an electric charge in an ion chamber (refer to Japanese Patent Application Laid-Open No. 08-033621), or the type that converts radiation to visible light through phosphor to be transmitted externally through an optical fiber and converts the radiation to an electric charge by a photomultiplier (refer to Japanese Patent Application Laid-Open No. 2003-322681). FIG. 18 shows a positional relation between an image sensing radiation detector 121 and an automatic x-ray exposure controller (AEC) 122 which constitute the conventional radiographic apparatus 120 in a case where the test body is the lungs 123.

The inventor of the present invention has proposed two methods of forming the above-described AEC sensor. One method is to layer the AEC sensor in the detector provided for image forming (refer to Japanese Patent Application Laid-Open No. 2002-139571). The other method is to embed the AEC sensor in the void between the detectors provided for image forming (refer to Japanese Patent Application Laid-Open No. 09-098970). Layering the sensor and embedding the sensor in the void both have respective advantages. More specifically, in the case of layering the AEC sensor, the aperture of the image forming sensor is not affected by incorporation of the AEC sensor. On the contrary, in the case of embedding the AEC sensor in the void, the manufacturing process can be simplified as long as the fluctuation of the aperture can be corrected by image processing.

However, the aforementioned proposals have not disclosed the relation between response speed of the detector for image forming and response speed of the detector for AEC. In other words, the time required for image forming and the sensor response time for controlling AEC have not been clarified.

### SUMMARY OF THE INVENTION

The present invention has been made in consideration of the above situation, and has as its object to obtain a desirable radiographed image while assuring an appropriate dose of exposure.

According to the present invention, the foregoing object is attained by providing a radiographic apparatus comprising: an image forming sensor for converting incident radiation to an electric signal and acquiring image data; and an AEC sensor formed on a same substrate as that of the image forming sensor, for converting incident radiation to an electric signal, wherein a time constant of the image forming sensor is set larger than a time constant of the AEC sensor.

Other features and advantages of the present invention will be apparent from the following description taken in conjunction with the accompanying drawings, in which like reference characters designate the same or similar parts throughout the figures thereof.

### BRIEF DESCRIPTION OF THE DRAWINGS

The accompanying drawings, which are incorporated in and constitute a part of the specification, illustrate embodiments of the invention and, together with the description, serve to explain the principles of the invention.

FIG. 1 is a schematic equivalent circuit diagram of a radiographic apparatus according to a first embodiment of the present invention;

FIG. 2 is a schematic plan view of the radiographic apparatus according to the first embodiment of the present invention;

FIG. 3 is another schematic plan view of the radiographic apparatus according to the first embodiment of the present invention;

FIGS. 4A and 4B are schematic cross sectional views of a one-pixel area of the radiographic apparatus according to the first embodiment of the present invention;

FIG. 5 shows graphs representing a relation between a time constant of an AEC sensor and a time constant of an image forming sensor;

FIG. 6 shows graphs representing a relation between a time constant of the AEC sensor and a time constant of the image forming sensor at the time of motion image sensing;

FIG. 7 is a schematic equivalent circuit diagram of a radiographic apparatus according to a second embodiment of the present invention;

FIG. 8 is a schematic plan view of the radiographic apparatus according to the second embodiment of the present invention;

FIG. 9 is another schematic plan view of the radiographic apparatus according to the second embodiment of the present invention;

FIGS. 10A and 10B are schematic cross sectional views of a one-pixel area of the radiographic apparatus according to the second embodiment of the present invention;

FIG. 11 is a schematic equivalent circuit diagram of a radiographic apparatus according to a third embodiment of the present invention;

FIG. 12 is a schematic plan view of the radiographic apparatus according to the third embodiment of the present invention;

FIG. 13 is a schematic cross sectional view of a one-pixel area of the radiographic apparatus according to the third embodiment of the present invention;

FIG. 14 is a schematic equivalent circuit diagram of a radiographic apparatus according to a fourth embodiment of the present invention;

FIG. 15 is an equivalent circuit diagram of a conventional image sensing radiation detector;

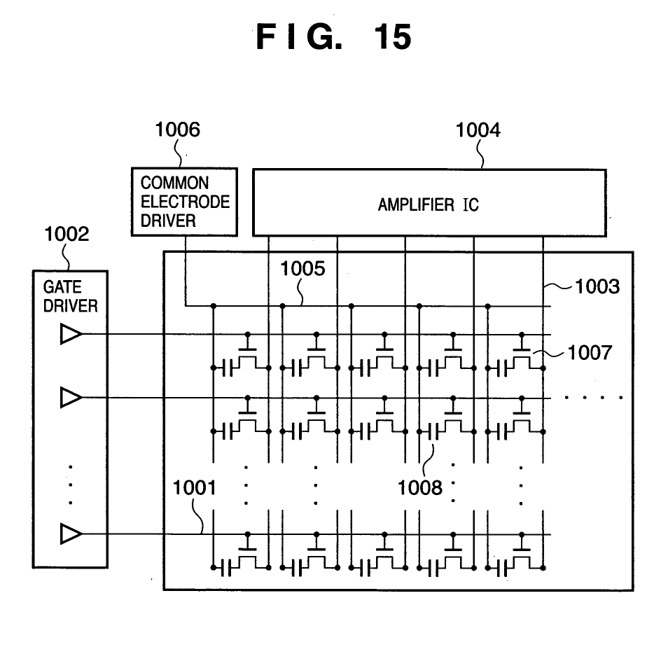

FIG. 16 is a plan view of the conventional image sensing radiation detector;

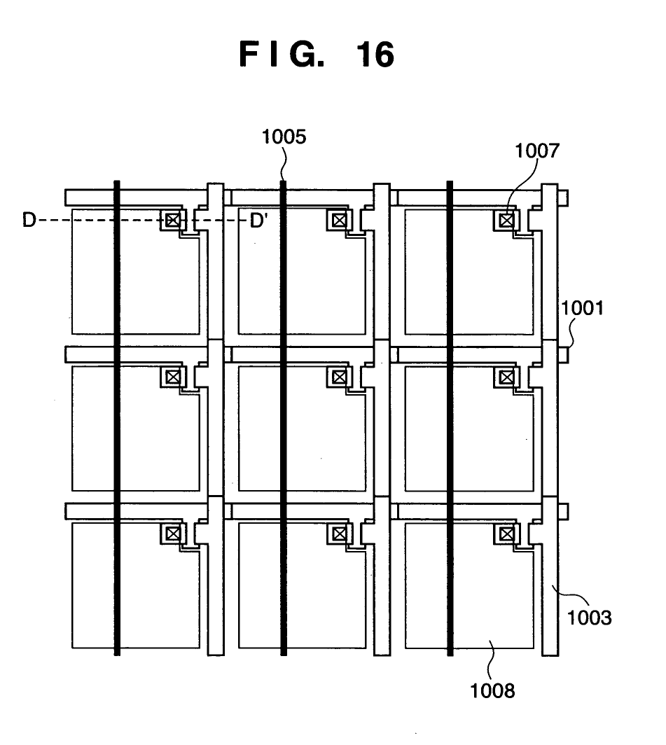

FIG. 17 is a schematic cross sectional view of a layer construction of one-pixel area configured with an MIS photoelectric converter and a TFT switch; and

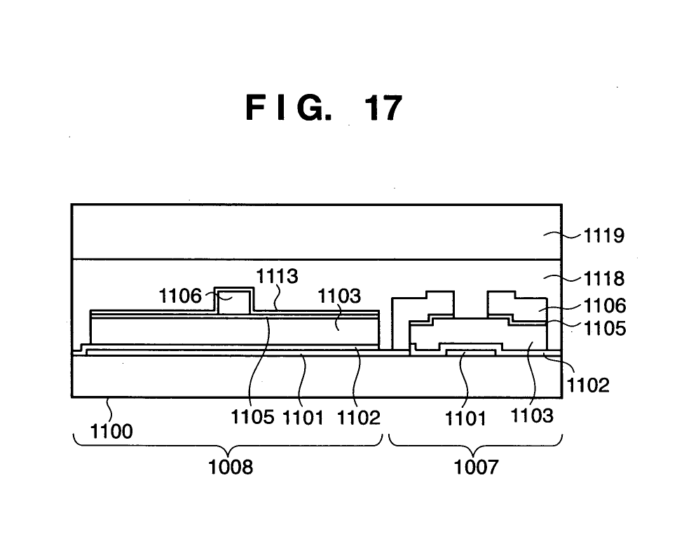

FIG. 18 is a view showing a positional relation between the image sensing radiation detector and the automatic x-ray exposure controller (AEC) which constitute the conventional radiographic apparatus.

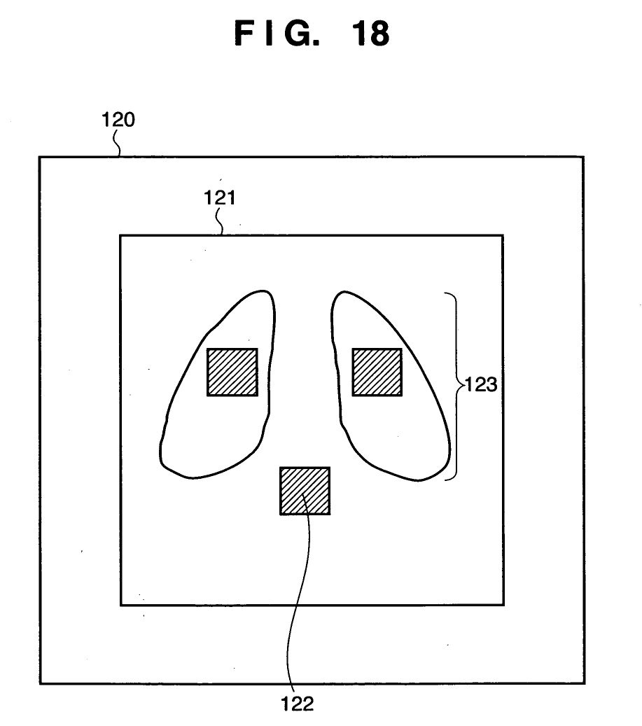

### DETAILED DESCRIPTION OF THE PREFERRED EMBODIMENTS

Preferred embodiments of the present invention will now be described in detail in accordance with the accompanying drawings. However, the dimensions, materials, shapes and relative positions of the constituent parts shown in the embodiments should be changed as convenient depending on various conditions and on the structure of the apparatus adapted to the invention, and the invention is not limited to the embodiments described herein.

### First Embodiment

According to the first embodiment of the present invention, in an image sensing radiation detector which constitutes a radiographic apparatus, a TFT switch and an AEC sensor (second photoelectric converter) are formed simultaneously, and an MIS photoelectric converter (first photoelectric converter) is layered thereupon through organic insulating film, thereby forming a radiographic device. Hereinafter, a description is provided with reference to the drawings on an example of thinning the light absorbing layer between the MIS photoelectric converters used for image sensing (first photoelectric converter) in a way that light is incident upon the void of the converters.

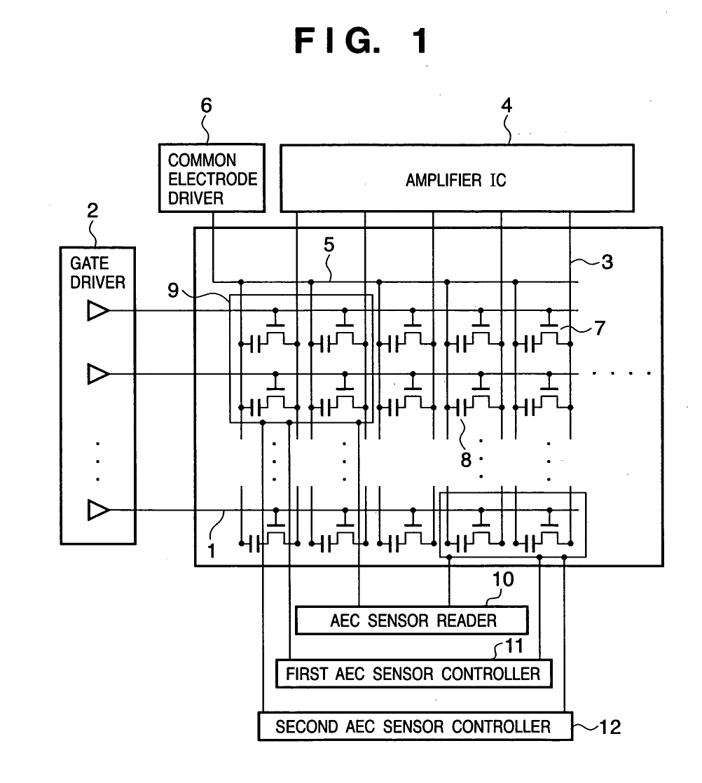

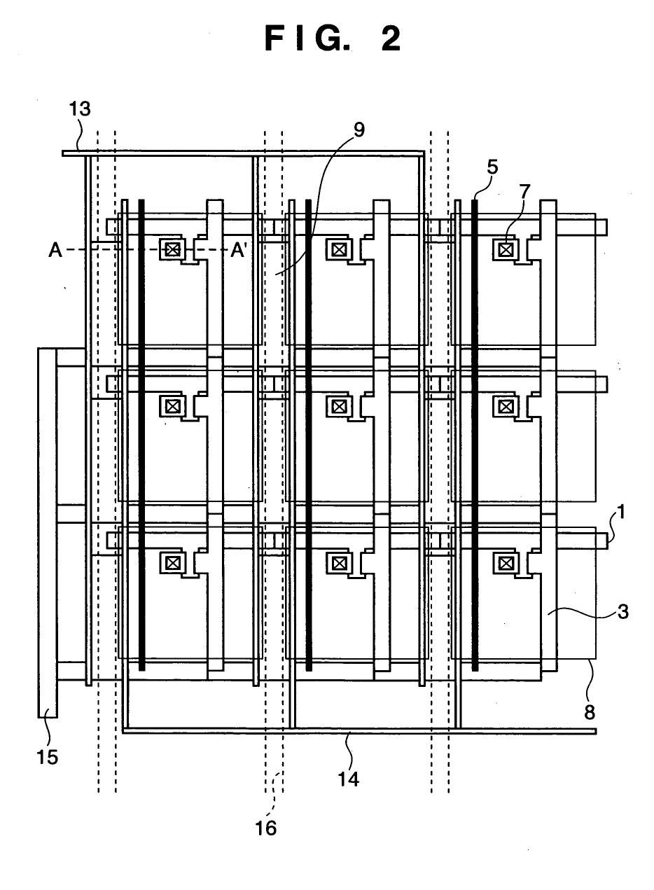

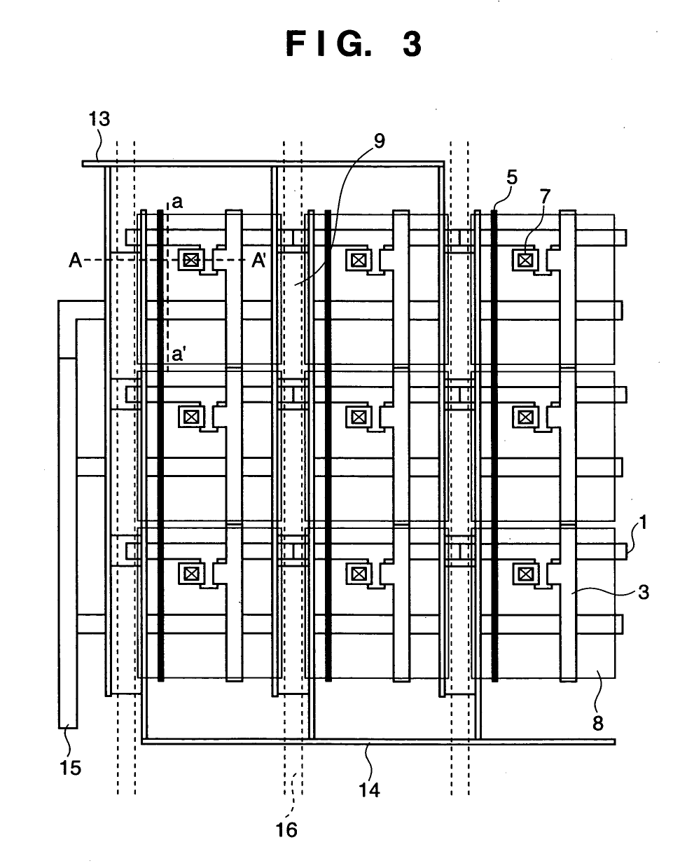

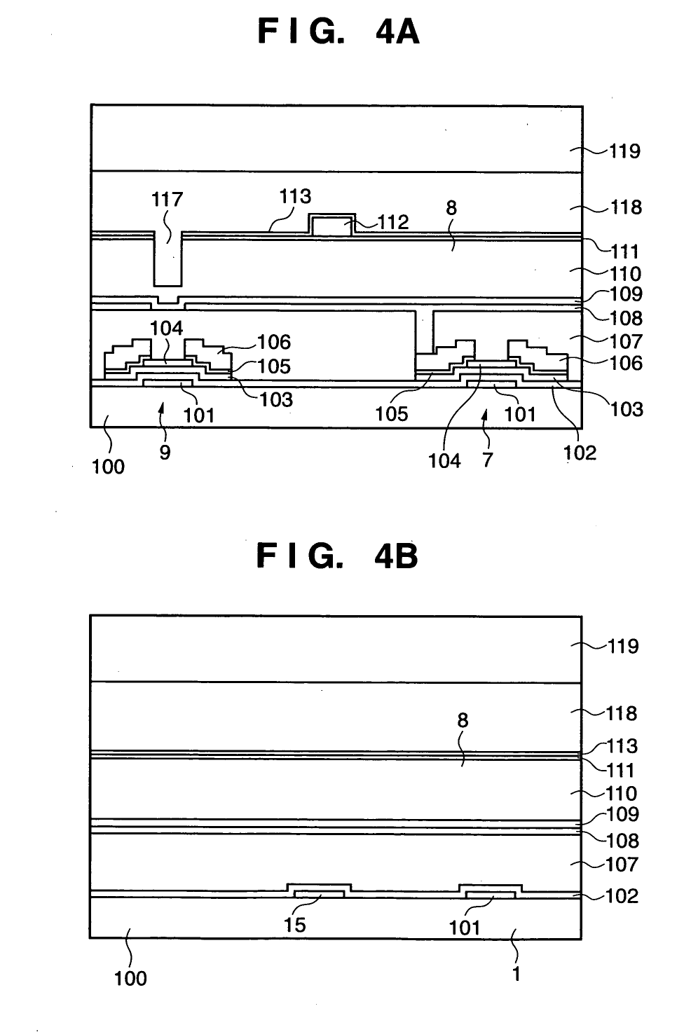

FIG. 1 is a schematic equivalent circuit diagram of a radiographic apparatus according to the first embodiment. FIGS. 2 and 3 are schematic plan views of the radiographic apparatus according to the first embodiment, showing two different types of configuration. FIG. 4A is a schematic cross sectional view taken along a line A-A′ in FIGS. 2 and 3, and shows a layer construction of one-pixel area of the radiographic apparatus shown in FIGS. 2 and 3. FIG. 4B is a schematic cross sectional view taken along a line a-a′ in FIG. 3, and shows a layer construction of one-pixel area of the radiographic apparatus shown in FIG. 3.

In FIGS. 1 to 3, numeral 8 denotes the first photoelectric converter configured with a semiconductor converter or the like, and numeral 7 denotes a TFT switch, both of which constitute a pixel. The second photoelectric converter 9 is configured across the plural numbers of pixel areas, and it is connected to an AEC sensor reader 10, a first AEC sensor controller 11, and a second AEC sensor controller 12.

Note that although the plan views in FIGS. 2 and 3 show a pixel area of 3×3 pixels, in reality, for instance 2000×2000 pixels are arranged on an insulated substrate. Furthermore, the second photoelectric converter 9 is arranged across the 2×2 pixel area. But in reality, each second photoelectric converter 9 is arranged across 200×200 pixels at least, and at least three or more of the second photoelectric converters 9 are arranged in the panel.

The first photoelectric converter 8 and TFT switch 7 are connected similarly to the conventional example. The gate electrodes of the TFT switches 7 are connected to a common gate wire 1, which is connected to a gate driver 2 controlling ON/OFF of the TFT switches 7. The source or drain electrodes of the respective TFT 7 are connected to a common signal wire 3, which is connected to an amplifier IC 4. Further, a bias wire 5 for driving the photoelectric converters is connected to a common electrode driver 6.

The source wire 14 and gate wire 15 of the second photoelectric converter 9 are connected respectively to the first AEC sensor controller 11 and the second AEC sensor controller 12. The second photoelectric converter 9 can always output electric charge corresponding to the dose of incident radiation. Therefore, constant potential is always applied. The electric charge detected by each second photoelectric converter 9 is transferred through the drain wire 13 and amplified by the AEC sensor reader 10. By adding the output of the reader 10, the total dose of incident radiation is detected.

Next, the layer construction of the radiographic apparatus according to the first embodiment is described with reference to FIG. 4A. FIG. 4A schematically shows a cross section cut along the line A-A′ in FIG. 2 or 3.

First, the TFT switch 7 and the second photoelectric converter 9 serving as an AEC sensor are formed on the glass substrate 100. A first conductive layer 101 is deposited by sputtering, then gate electrodes and gate wires (e.g., AlNd/Mo 2500 Å) of the TFT switch 7 and second photoelectric converter 9 are formed, and on top of that, a first insulating layer 102 (e.g., SiN 3000 Å), a first semiconductor layer (first light absorbing layer) 103 (e.g., a-Si 1500 Å), and a second insulating layer 104 (e.g., SiN 2000 Å) are sequentially deposited by chemical vapor deposition (CVD). The second insulating layer 104 is formed as the protection film between each source and drain on the gate electrodes and gate wires by exposing with light from backside.

Next, a first ohmic contact layer 105 (e.g., a-Si (n+) 200 Å) and a second conductive layer 106 (e.g., Mo/Al/Mo 4000 Å) are deposited respectively by CVD and sputtering, thereby forming respective source and drain electrodes as well as wiring. On top of this, a third insulating layer 107 (e.g., organic film BCB (benzocyclobutene)) serving as a protection layer is formed. In this manner, according to the first embodiment, the TFT switch 7 and second photoelectric converter 9 are simultaneously formed, thereby realizing an image sensing circuit board having the TFT switch 7 and second photoelectric converter 9 on the same layer.

Furthermore, a third conductive layer 108 (e.g., Mo/Al/Mo 4000 Å) is deposited by sputtering. The third conductive layer 108 connects with the source or drain electrode of the TFT switch 7 through a contact hole, and is separated in pixel unit as the lower electrode of the first photoelectric converter 8. On top of the layer 108, a fourth insulating layer 109 (e.g., SiN 2000A), a second semiconductor layer (second light absorbing layer) 110 (e.g., a-Si 5000 Å), and a second ohmic contact layer 111 (e.g., a-Si (n+) 200 Å) are sequentially deposited by CVD.

Furthermore, a fourth conductive layer 112 (e.g., Mo/Al/Mo 4000 Å) is deposited by sputtering to form bias wires of the first photoelectric converter 8. Then, a transparent conductive layer 113 (e.g., ITO 200 Å) is deposited by sputtering. In order to make light incident on the second photoelectric converter 9 (light propagation area 16 in FIGS. 2 and 3), wet-etching and dry-etching are performed on the transparent conductive layer 113, second ohmic contact layer 111, and second semiconductor layer (second light absorbing layer) 110 over the striped area along the source/drain wires of the second photoelectric converter 9, thereby forming a recess 117 on the second semiconductor layer 110.

In this stage, it is preferable to completely remove the second semiconductor layer (second light absorbing layer) 110 in the light propagation area 16 to form an open hole pattern, because the dose of incident radiation to the second photoelectric converter 9 increases. However, even if the layer 110 is etched halfway as shown in FIG. 4A, it is functionable as long as the absorption in the second semiconductor layer 110 is 50% or less. Furthermore in the first embodiment, although the light propagation area 16 is formed in the striped shape along the source/drain wires of the second photoelectric converter 9 (see FIG. 4A), the second semiconductor layer (second light absorbing layer) 110 may be separated for each pixel.

Thereafter, a protection layer 118 (e.g., SiN and organic film) and phosphor 119 are formed on the top surface.

Hereinafter, a description is provided on the time constants of the first photoelectric converter 8 and second photoelectric converter 9. The photoelectric converter is equivalently formed with a charge storage capacitance C and a resistance component R of the switch unit (TFT or the like).

Defining a charge storage capacitance and a resistance component of the first photoelectric converter 8 as C1 and R1, respectively, the time constant RC1 of the amount of charge transfer in a case where the switch is turned on by controlling the gate wire 1 after an electric charge is stored is expressed by RC1=R1×C1. Empirically, it is known that, in order to assure data accuracy, more than five times the time constant needs to be secured before sampling and holding. Therefore, data is determined after a lapse of time (5×RC1) since the switch is turned on by gate wire 1.

Similarly defining a charge storage capacitance and a resistance component of the second photoelectric converter 9 as C2 and R2, respectively, the time constant RC2 of the amount of charge transportation in a case where the switch is turned on by controlling of the gate wire 15 after an electric charge is stored is expressed by RC2=R2×C2. Similarly, it is empirically known that, in order to assure data accuracy, more than five times the time constant needs to be secured before sampling and holding. Therefore, data is determined after a lapse of time (5×RC2) since the switch is turned on by gate wire 15.

The relation of levels between RC1 and RC2 is now described. RC1 represents a response time of the first photoelectric converter 8 for image forming, and RC2 represents a response time of the second photoelectric converter 9 for AEC. It is preferable that the radiographic apparatus be constructed to satisfy RC1>RC2. Reason thereof is as follows.

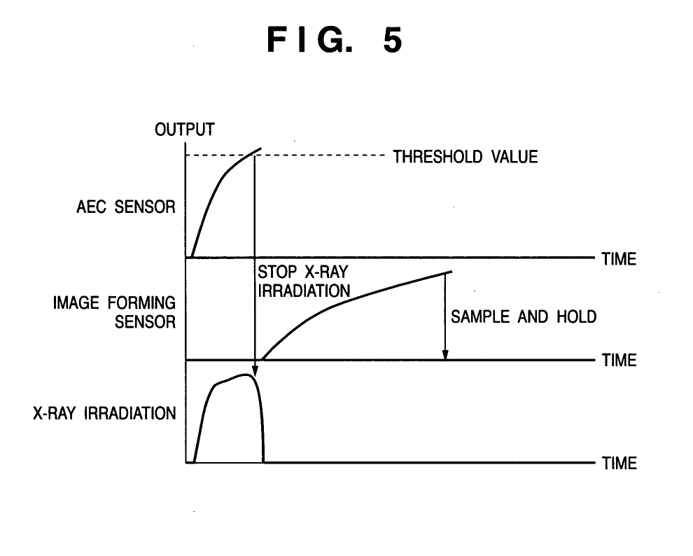

A threshold value is set for an AEC sensor output, and when the output reaches the set value, the X-ray irradiation is stopped. Delay in termination of the X-ray irradiation results in unnecessary radiation exposure of a patient, which is not desirable as a medical device. If the time constant is large, the detection of reaching the set value is delayed. Therefore, it is desirable that the response speed of the AEC sensor used for termination of the X-ray irradiation be sufficiently higher than the response speed of the image forming sensor. This relation is shown in FIG. 5.

An output of the AEC sensor increases along with X-ray irradiation. When the output reaches the threshold value, X-ray irradiation is stopped and data of the image forming sensor is read after a lapse of predetermined time. FIG. 5 shows a preferred example. If the time constant of the AEC sensor is large, the X-ray irradiation becomes unnecessarily large. The reason for specifying the relation of levels between RC1 and RC2 is that the number of pixels is extremely larger in the image forming sensor than the AEC sensor, and satisfying RC1>RC2 offers an advantage in image quality.

In a case where an AEC sensor of slow response speed is employed, it is possible to predict the time the AEC output reaches the threshold value in order to decrease unnecessary radiation exposure. However, the accuracy of prediction is not satisfactory.

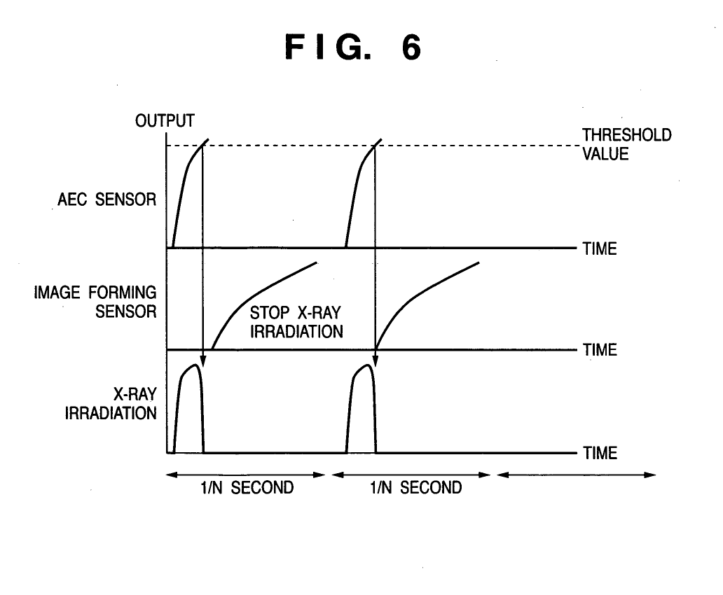

FIG. 5 shows an example in which one image acquisition is achieved for one X-ray irradiation. Also in the case of sensing a motion image where N images are acquired per second, the dose of X-ray irradiation needs to be controlled similarly by the AEC sensor. As shown in FIG. 6, in order to detect X-ray irradiation in (1/N) second and terminate the X-ray irradiation with sufficient accuracy, it is empirically known that ten times the response speed of the motion image interval is necessary. More specifically, it is desirable to form the AEC sensor to satisfy 5×RC2≦0.1/N seconds.

Although the first embodiment employs an MIS photoelectric converter as the first photoelectric converter 8, a PIN photoelectric converter may be employed as a matter of course. Furthermore, although the first embodiment employs a TFT photoelectric converter comprising a gate, source and drain as the second photoelectric converter 9, a construction excluding the gate can realize sufficient performance. However, in a case of the construction excluding the gate, a resistance between the source and drain is considered as R instead of the resistance of a switch device.

By arranging the gate wire 15 of the second photoelectric converter 9 in the void between the lower electrodes of the first photoelectric converters 8 as shown in FIG. 2, generation of parasitic capacitance between the gate wire 15 and first photoelectric converter 8 can be avoided, which is advantageous in terms of noise and the like. In the meantime, arranging the gate wire 15 directly beneath the lower electrode of the first photoelectric converter 8 as shown in FIGS. 3 and 4B can give a wide area for the lower electrode of the first photoelectric converter 8, thus contributing to improved signal values. Furthermore, in the first embodiment, the first photoelectric converter 8 is formed also on the portion above the TFT 7 as shown in FIGS. 2 and 3, thereby assuring a high aperture of the first photoelectric converter 8. However, the portion above the TFT 7 may be excluded from the first photoelectric converter 8 forming area.

According to the first embodiment, by setting a larger time constant for the first photoelectric converter than that of the AEC sensor (second photoelectric converter), it is possible to obtain a desirable radiographed image while assuring an appropriate dose of exposure.

Furthermore, since the AEC sensor (second photoelectric converter) is incorporated simultaneously in the substrate of the image sensing radiation detector, it is no longer necessary to provide an automatic x-ray exposure controller (AEC) as a separate component. Therefore, the radiographic apparatus can be downsized. Also, since the substrate manufacturing process of the image sensing radiation detector can be utilized, it is advantageous in terms of cost.

Moreover, the AEC sensor can also be used as a radiation monitor. A radiation monitor detects ON/Off of the radiation incident upon the image sensing radiation detector and controls detection of the image sensing radiation detector. This is not only limited to the first embodiment, but is applicable to all of the following embodiments.

### Second Embodiment

Next, the second embodiment of the present invention is described.

According to the second embodiment of the present invention, in an image sensing radiation detector which constitutes a radiographic apparatus, a TFT switch and an AEC sensor (second photoelectric converter) are formed simultaneously, and a PIN photoelectric converter (first photoelectric converter) is layered thereupon through organic insulating film. Hereinafter, a description is provided with reference to the drawings on the construction where the light absorbing layer between the PIN photoelectric converters (first photoelectric converter) used for image sensing is removed in a way that light is incident upon the void of the converters.

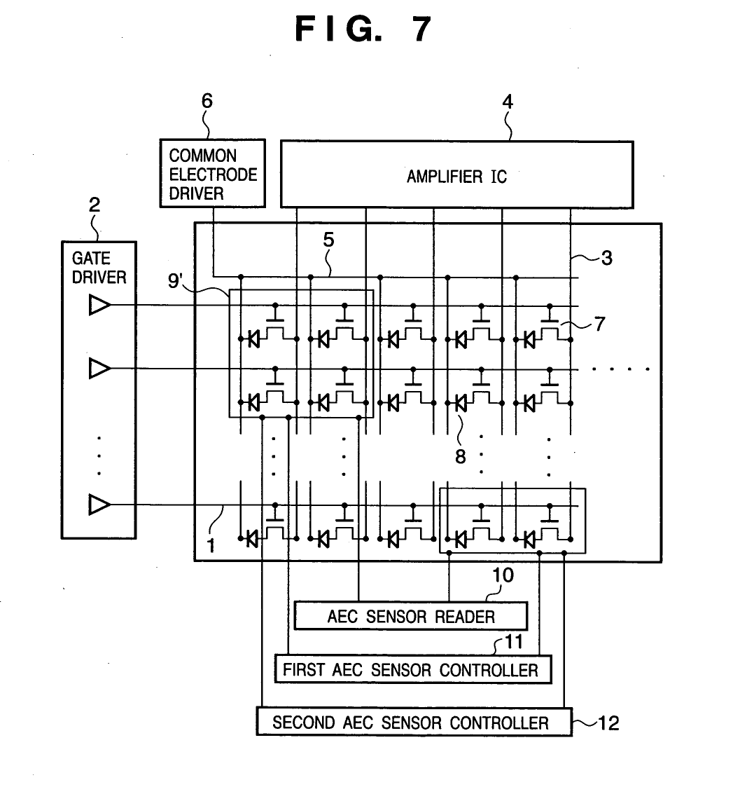

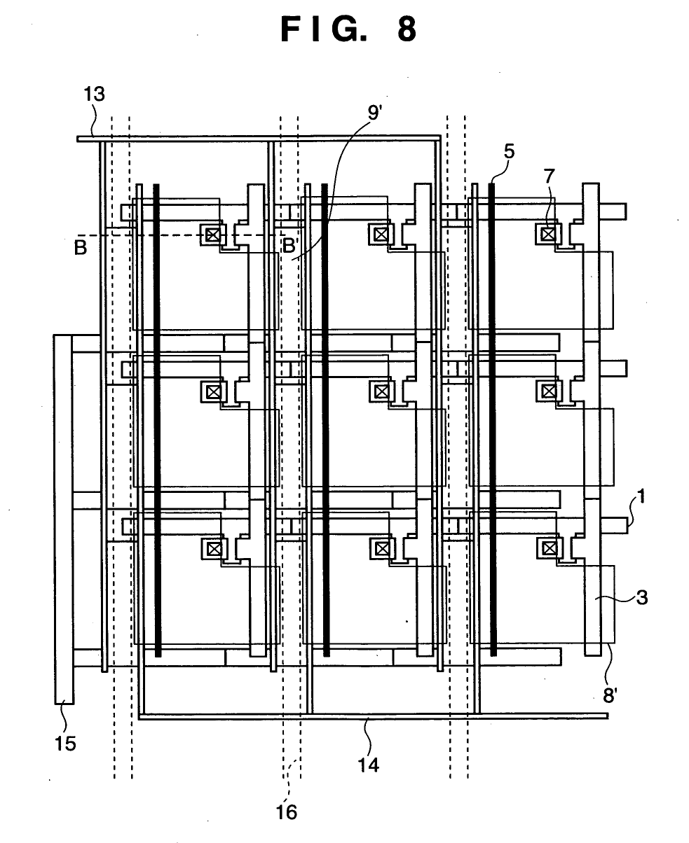

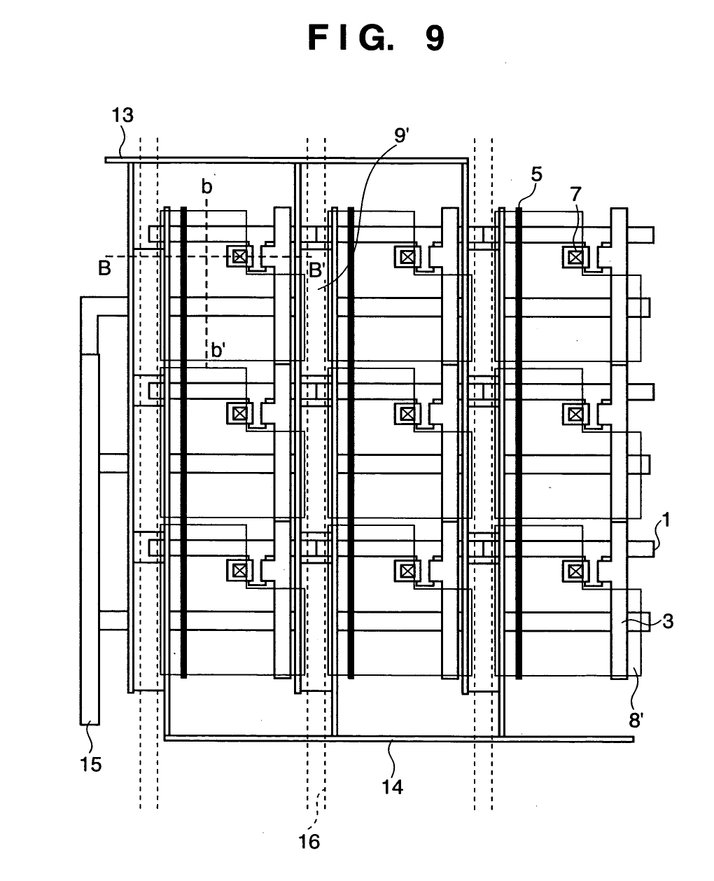

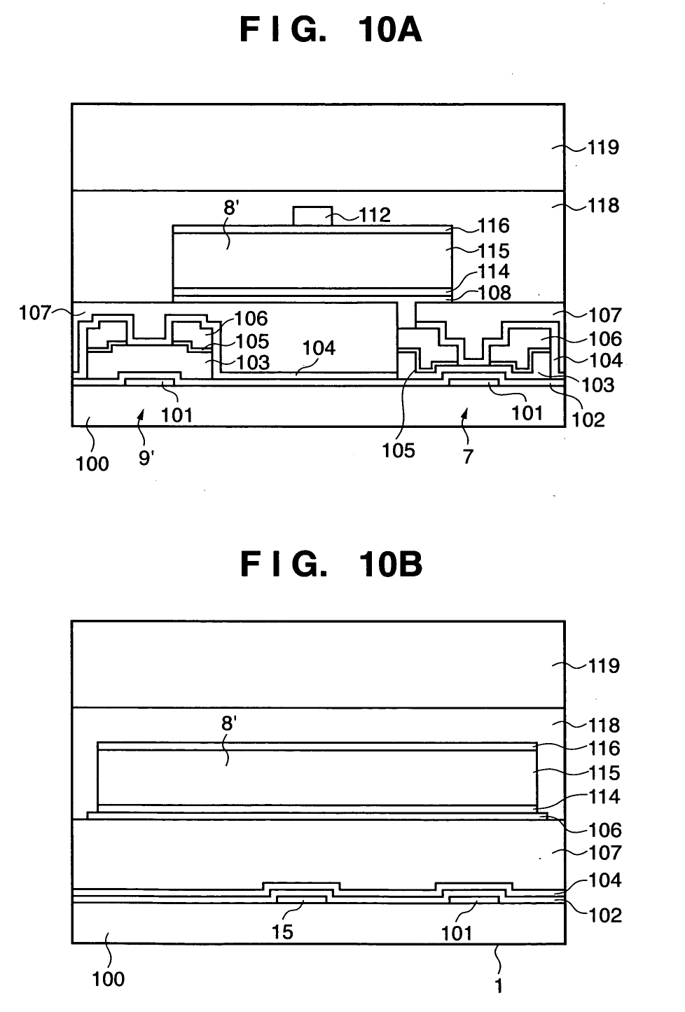

FIG. 7 is a schematic equivalent circuit diagram of a radiographic apparatus according to the second embodiment. FIGS. 8 and 9 are schematic plan views of the radiographic apparatus according to the second embodiment, showing two different types of configuration. FIG. 10A is a schematic cross sectional view taken along the line B-B′ in FIGS. 8 and 9, and shows a layer construction of one-pixel area of the radiographic apparatus shown in FIGS. 8 and 9. FIG. 10B is a schematic cross sectional view taken along the line b-b′ in FIG. 9, and shows a layer construction of one-pixel area of the radiographic apparatus shown in FIG. 9.

Note, for the components similar to that of FIGS. 1 to 3, the same reference numerals are assigned in FIGS. 7 to 9. In FIGS. 7 to 9, numeral 8′ denotes a first photoelectric converter such as a semiconductor converter, and numeral 7 denotes a TFT switch, both of which constitute a pixel. A second photoelectric converter 9′ is configured across the plural numbers of pixel areas, and it is connected to the AEC sensor reader 10, the first AEC sensor controller 11, and the second AEC sensor controller 12.

Note that although the plan views in FIGS. 8 and 9 show a pixel area of 3×3 pixels, in reality, for instance 2000×2000 pixels are arranged on an insulated substrate. Furthermore, the second photoelectric converter 9′ is arranged across the 2×2 pixel area. But in reality, each second photoelectric convert 9′ is arranged across 200×200 pixels at least, and at least three or more of them are arranged in the panel.

The first photoelectric converter 8′ and TFT switch 7 are connected similarly to the conventional example. The gate electrodes of the TFT switches 7 are connected to a common gate wire 1, which is connected to a gate driver 2 controlling ON/OFF of the TFT switches 7. The source or drain electrodes of the respective TFT 7 are connected to a common signal wire 3, which is connected to an amplifier IC 4. Further, a bias wire 5 for driving the photoelectric converters is connected to a common electrode driver 6 as shown in FIG. 3.

The source wire 14 and gate wire 15 of the second photoelectric converter 9′ are connected respectively to the first AEC sensor controller 11 and the second AEC sensor controller 12. The second photoelectric converter 9′ can always output an electric charge corresponding to the dose of incident radiation. Therefore, an constant potential is always applied. The electric charge detected by each second photoelectric converter 9′ is transferred through the drain wire 13 and amplified by the AEC sensor reader 10. By adding the output of the reader 10, the total dose of incident radiation is detected.

Next, the layer construction of the radiographic apparatus according to the second embodiment is described with reference to FIG. 10A. FIG. 10A schematically shows a cross section cut along the line B-B′ in FIG. 8 or 9.

First, the TFT switch 7 and the second photoelectric converter 9′ serving as an AEC sensor are formed on the glass substrate 100. A first conductive layer 101 is deposited by sputtering, then gate electrodes and gate wires (e.g., AlNd/Mo 2500 Å) of the TFT switch 7 and second photoelectric converter 9′ are formed, and on top of that, a first insulating layer 102 (e.g., SiN 3000 Å) and a first semiconductor layer (first light absorbing layer) 103 (e.g., a-Si 5000 Å) are sequentially deposited by CVD.

Since it is preferable that the TFT 7 has high transfer speed, it is desirable that the first semiconductor layer 103 is a thin layer. Accordingly, only the TFT portion of the first semiconductor layer 103 is thinned by half etching. Next, a first ohmic contact layer 105 (e.g., a-Si (n+) 200 Å) and a second conductive layer 106 (e.g., Mo/Al/Mo 4000 Å) are deposited respectively by CVD and sputtering, thereby forming respective source and drain electrodes as well as wiring.

On top of this, a second insulating layer 104 (e.g., SiN 2000 Å) is deposited by CVD for particularly protecting a channel portion of the TFT 7, and further a third insulating layer 107 (e.g., organic film BCB (benzocyclobutene)) serving as a protection layer is formed.

Furthermore, a third conductive layer 108 (e.g., Mo/Al/Mo 4000 Å) is deposited by sputtering. The third conductive layer 108 connects with the source or drain electrode of the TFT switch 7 through a contact hole, and is separated in pixel unit as the lower electrode of the first photoelectric converter 8′ so that the layer 108 does not fall over the portion above the TFT 7. On top of the layer 108, an n type semiconductor layer 114 (e.g., a-Si (P) 1000 Å), a high resistance semiconductor layer (second light absorbing layer) 115 (e.g., a-Si 5000 Å), and a p type semiconductor layer 116 (e.g., a-Si (N) 1000 Å) are sequentially deposited by CVD. Furthermore, a fourth conductive layer 112 (e.g., Mo/Al/Mo 4000 Å) is deposited by sputtering to form bias wires of the first photoelectric converter 8′.

In order to assure separation of each pixel and secure the light propagation path to the second photoelectric converter 9′, dry-etching is performed (device separation) on the n type semiconductor layer 114, high resistance semiconductor layer (second light absorbing layer) 115, and p type semiconductor layer 116 in the shape taken along the lower electrode of the first photoelectric converter 8′. In the second embodiment, although the n type semiconductor layer 114, high resistance semiconductor layer (second light absorbing layer) 115, and p type semiconductor layer 116 are separated for each pixel by the shape taken along the lower electrode of the first photoelectric converter 8′ as shown in FIG. 10A, it is preferable to form a light propagation area 16 in the striped shape along the source/drain wires of the second photoelectric converter 9′ as described in the first embodiment because a higher aperture of the first photoelectric converter 8′ is achieved. Thereafter, a protection layer 118 (e.g., SiN and organic film) and phosphor 119 are formed on the top surface.

As similar to the first embodiment, when the time constant of the first photoelectric converter 8′ is expressed by RC1 and the time constant of the second photoelectric converter 9′ is expressed by RC2, it is preferable that RC1>RC2 be satisfied in the above construction.

Although the second embodiment employs a PIN photoelectric converter as the first photoelectric converter 8′, an MIS photoelectric converter may be employed as a matter of course. Furthermore, although the second embodiment employs a TFT photoelectric converter comprising a gate, source and drain as the second photoelectric converter 9′, a construction excluding the gate can realize sufficient performance.

By arranging the gate wire 15 of the second photoelectric converter 9′ in the void between the lower electrodes of the second photoelectric converters 9′ as shown in FIG. 8, generation of parasitic capacitance between the gate wire 15 and first photoelectric converter 8′ can be avoided, which is advantageous in terms of noise and the like. In the meantime, arranging the gate wire 15 directly beneath the lower electrode of the second photoelectric converter 9′ as shown in FIGS. 9 and 10B can give a wide area for the lower electrode of the first photoelectric converter 8′, thus contributing to improved signal values. Moreover, in the second embodiment, the portion above the TFT 7 is excluded from the first photoelectric converter 8′ forming area. However, taking a light leak current of the TFT 7 into consideration, the photoelectric converter 8′ may be formed in the portion above the TFT 7 as shown in FIG. 4A of the first embodiment so as to reduce the light incident upon the TFT 7.

As set forth above, the second embodiment can achieve the same effects as the first embodiment.

### Third Embodiment

Next, the third embodiment of the present invention is described.

According to the third embodiment of the present invention, in an image sensing radiation detector which constitutes a radiographic apparatus, a TFT switch is formed and a radiation direct detection material (first radiation converter), typified by amorphous selenium (a-Se) or gallium arsenide (GaAs), is layered thereupon through organic insulating film. Hereinafter, a description is provided with reference to the drawings on an example where an AEC sensor (second radiation converter) is provided between the first radiation converters.

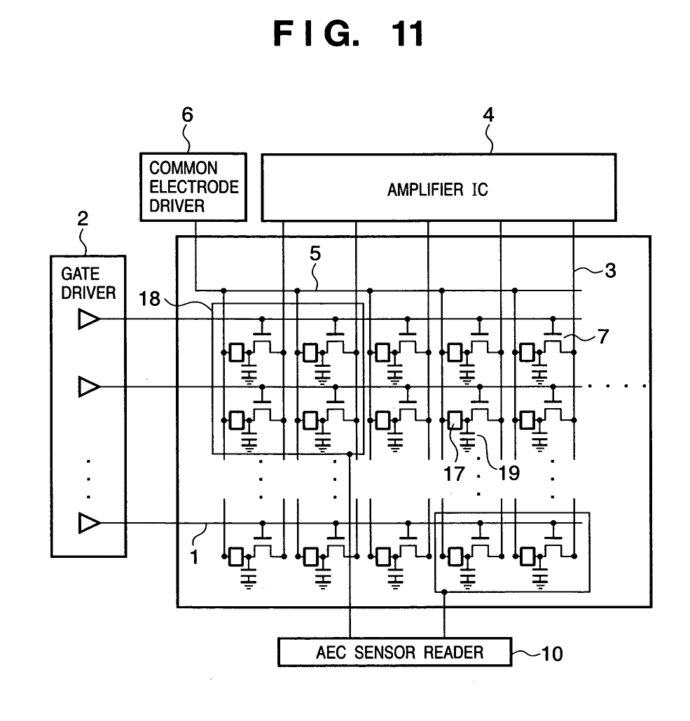

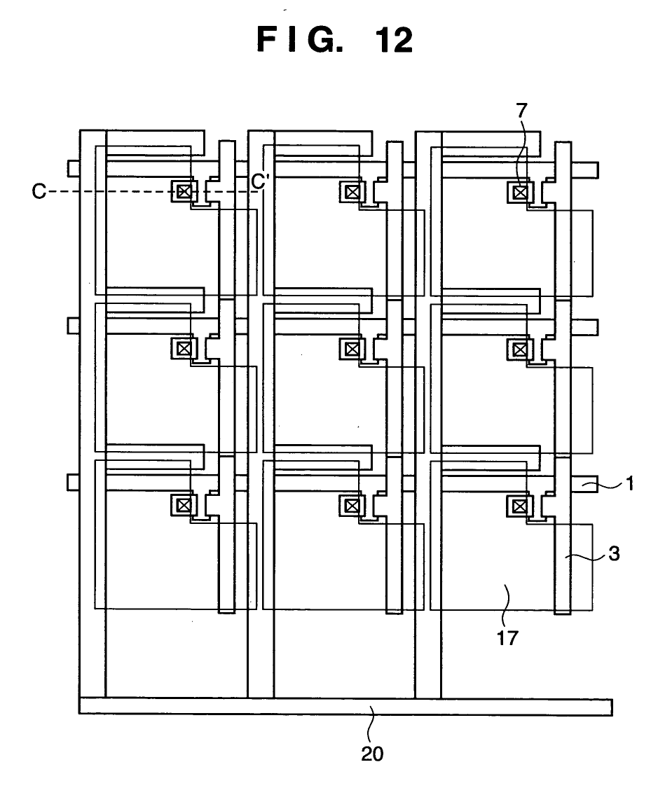

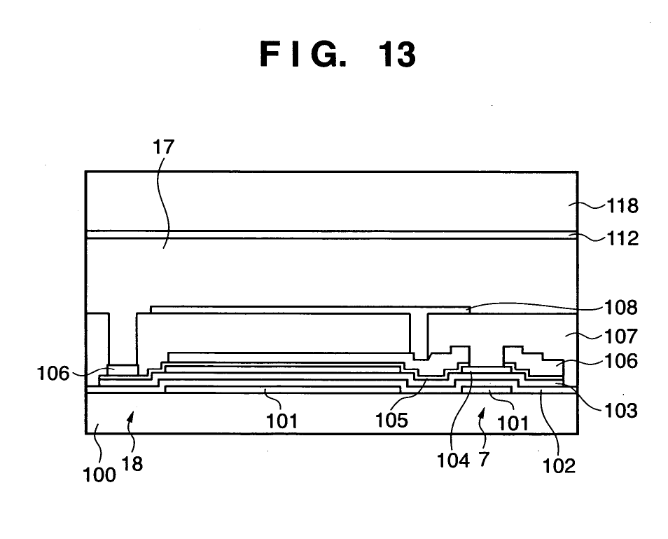

FIG. 11 is a schematic equivalent circuit diagram of a radiographic apparatus according to the third embodiment. FIG. 12 is a schematic plan view of the radiographic apparatus according to the third embodiment. FIG. 13 is a schematic cross sectional view taken along the line C-C′ in FIG. 12, and shows a layer construction of one-pixel area of the radiographic apparatus shown in FIG. 12. Note, for the components similar to that of FIGS. 1 to 4 and FIGS. 7 to 10, the same reference numerals are assigned in FIGS. 11 to 13.

In FIGS. 11 and 12, numeral 17 denotes a first radiation converter such as a semiconductor converter, and numeral 7 denotes a TFT switch, both of which constitute a pixel. A second radiation converter 18 is configured across the plural numbers of pixels. The first and second radiation converters 17 and 18 share the bias wire 5. A lower electrode wire 20 which is intrinsic of the second radiation converter 18 is connected to the AEC sensor reader 10.

Note that although the plan view in FIG. 12 shows a pixel area of 3×3 pixels, in reality, for instance 2000×2000 pixels are arranged on an insulated substrate. Furthermore, the second radiation converter 18 is arranged across the 2×2 pixel area in FIG. 11. But in reality, each second radiation converter 18 is arranged across 200×200 pixels at least, and at least three or more of them are arranged in the panel.

Radiation irradiated to a test body is attenuated as it transmits through the test body, and is incident upon the first radiation converter 17 configured with, e.g., a-Se. When the radiation is incident upon the first radiation converter 17, plus and minus electric charges corresponding to the incident radiation energy are generated due to a photoconductive effect. Using the bias wire 5 connected to the common electrode driver 6, several kilovolts of voltage is applied across the ends of the first radiation converter 17 so that the generated electric charge can be extracted as flux of light along the electric field. The electric charge generated in the first radiation converter 17 for image sensing is stored in a storage capacitor 19 arranged on the insulated substrate. The stored electric charge is transferred to the signal wire 3 through the TFT 7, and read out by an external unit through the amplifier IC 4. The gate electrodes of the TFT 7 are connected to the common gate wire 1, which is connected to the gate driver 2 controlling ON/OFF of the TFT 7.

Meanwhile, the second radiation converter 18 is arranged between the bias wire 5 (upper electrode) and the lower electrode wire 20. By always applying a constant potential, the second radiation converter 18 can output an electric charge corresponding to the dose of incident radiation. The generated electric charge is amplified by the AEC sensor reader 10 which is directly connected through the lower electrode. By adding the output of the reader 10, the total dose of incident radiation is detected.

Next, the layer construction of the radiographic apparatus according to the third embodiment is described with reference to FIG. 13.

A first conductive layer 101 is deposited on the glass substrate 100 by sputtering, then gate electrodes and gate wires of the TFT switch 7 and the lower electrode of the storage capacitor 19 for the second radiation converter 18 are formed (e.g., AlNd/Mo 2500 Å). On top of that, a first insulating layer 102 (e.g., SiN 3000 Å), a first semiconductor layer (first light absorbing layer) 103 (e.g., a-Si 1500 Å), and a second insulating layer 104 (e.g., SiN 2000 Å) are sequentially deposited by CVD. The second insulating layer 104 is formed on the first conductive layer 101 by exposing with light from backside as the protection film between the source and drain of the TFT 7.

Next, a first ohmic contact layer 105 (e.g., a-Si (n+) 200 Å) and a second conductive layer 106 (e.g., Mo/Al/Mo 4000 Å) are deposited respectively by CVD and sputtering, thereby forming respective source and drain electrodes as well as wiring, and the lower electrode wire 20 of the second radiation converter 18. On top of this, a third insulating layer 107 (e.g., organic film BCB (benzocyclobutene)) serving as a protection layer is formed. Contact holes on the source or drain electrodes of TFT 7 switches, and the third insulating layer 107 in the portion of the lower electrode wire 20 of the second radiation converter 18 are removed by etching.

Furthermore, a third conductive layer 108 (e.g., Cu 2000 Å) is deposited by sputtering. The third conductive layer 108 connects with the source or drain electrode of the TFT switch 7 through the contact hole, and is separated in pixel unit as the lower electrode of the first radiation converter 17. On top of the layer 108, the first radiation converter 17 is formed. Furthermore, a fourth conductive layer 112 (e.g., Mo/Al/Mo 4000 Å) is deposited by sputtering. Thereafter, a protection layer 118 (e.g., SiN and organic film) is formed on the top surface.

As similar to the first embodiment, when the time constant of the first radiation converter 17 is expressed by RC1 and the time constant of the second radiation converter 18 is expressed by RC2, it is preferable that RC1>RC2 be satisfied in the above construction.

In the third embodiment, although the electric charge generated in the second radiation converter 18 serving as an AEC sensor is directly read through the lower electrode wire 20, the electric charge can be read after it is stored if an electrode intrinsic of the first conductive layer 101 is formed. Moreover, in the third embodiment, the first radiation converter 17 is not formed on the portion above the TFT 7 as shown in FIG. 13. However, the first radiation converter 17 may be formed also in the portion above the TFT 7 as shown in FIG. 10A of the second embodiment so as to decrease the light incident upon the TFT 7 in consideration of light leak current of the TFT7.

As set forth above, the third embodiment can achieve the same effects as the first embodiment.

### Fourth Embodiment

Next, the fourth embodiment of the present invention is described.

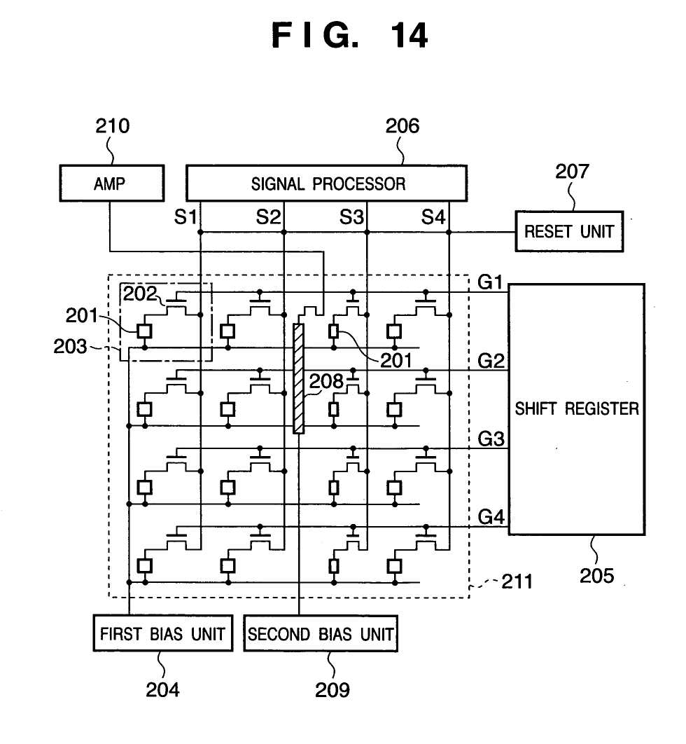

FIG. 14 is a schematic equivalent circuit diagram of a radiographic apparatus according to the fourth embodiment. As shown in FIG. 14, in the radiographic apparatus according to the fourth embodiment, each pixel 203 is constructed with a first photoelectric converter 201 and a transistor 202 serving as a transfer switch that is connected to the first photoelectric converter 201. Although FIG. 14 shows an area configured with 16 pixels where 4 cells in the column and 4 cells in the row are two-dimensionally arranged, in reality, for instance, 2000×2000 pixels are arranged on an insulated substrate.

The first photoelectric converters 201, which are two-dimensionally arranged at equal intervals p, are connected to a first bias unit 204. Each gate of the transistor 202 is connected to a shift register 205 through gate wires G1 to G4 provided for respective rows. An output signal of the transistor 202 is transferred to a signal processor 206 comprising an amplifier, a multiplexer, and an A/D converter, through signal wires S1 to S4 provided for respective columns and subjected to sequential signal processing. The signal wires S1 to S4 provided for respective columns of the transistor 202 are connected to a reset unit 207.

Further, the radiographic apparatus shown in FIG. 14 includes a second photoelectric converter 208 having an elongated shape, which is different from the first photoelectric converter 201 provided for sensing a normal image.

In the foregoing construction, an electric charge generated by the first photoelectric converter 201 corresponding to the row selected by the shift register 205 is read out through the transistor 202 and transferred to the signal processor 206, selectively amplified, and subjected to A/D conversion. After the electric charge is read, charge reset operation is performed by the reset unit 207. Note that this operation may not be necessary depending on the construction of the radiographic apparatus.

The elongated second photoelectric converter 208 is arranged across the pixels 203 and between the signal wires (S2 and S3) in the column direction. In the fourth embodiment, since the second photoelectric converter 208 is arranged on the same plane as the first photoelectric converter 201, the first photoelectric converter 201′ adjacent to the second photoelectric converter 208 has a smaller area than the other first photoelectric converter 201.

The second photoelectric converter 208 is connected to a second bias unit 209. At the time of reading an electric charge, the second photoelectric converter 208 can always output an electric charge corresponding to the dose of incident radiation without being selected by the shift register 205. Therefore, an constant potential is always applied. The electric charge detected by the second photoelectric converter 208 is amplified by an amplifier 210. By adding the output of the amplifier 210, the total dose of incident radiation is detected.

According to the fourth embodiment, since the AEC controlling sensor (second photoelectric converter 208) is incorporated in the photoelectric converter substrate 211, it is no longer necessary to provide an AEC controlling sensor as a separate component. Therefore, the radiation detector can be downsized and circuit structure thereof can be simplified. Furthermore, by virtue of having the AEC controlling sensor separately from the sensor used for image data (first photoelectric converter 201), and by separately providing processing circuits, it is no longer necessary to perform high-speed driving to read out electric charges. Therefore, it is possible to prevent radiograph images from deterioration.

Furthermore, the AEC controlling sensor (second photoelectric converter 208) is arranged in a way that the sensor intersects with the driving wires in the row direction and extends across a plurality of pixels, while the sensor is arranged in parallel with signal wires S1 to S4 in the column direction so as not intersect with the signal wires S1 to S4. By virtue of this arrangement, parasitic capacitance does not generated in the signal wires S1 to S4. Therefore, it is possible to read an output signal having a high S/N ratio. Further, it is preferable to extend the AEC controlling sensor 208 across a plurality of pixels in the direction parallel with the signal wires, since a radiation dose can be averaged and detected in a wide area.

As already described in the first embodiment, when the response time of the first photoelectric converter 201 for image forming is expressed by RC1 and the response time of the second photoelectric converter 208 for AEC is expressed by RC2, it is preferable that RC1>RC2 be satisfied in the radiographic apparatus of the fourth embodiment.

As many apparently widely different embodiments of the present invention can be made without departing from the spirit and scope thereof, it is to be understood that the invention is not limited to the specific embodiments thereof except as defined in the claims.

What is claimed is:

1. A radiographic apparatus comprising:
an image forming sensor for converting incident radiation to an electric signal and acquiring image data; and
an AEC sensor formed on a same substrate as that of said image forming sensor, for converting incident radiation to an electric signal,
wherein a time constant of said image forming sensor is set larger than a time constant of said AEC sensor.

2. The radiographic apparatus according to claim 1, wherein each of said image forming sensor and said AEC sensor has a capacitance and a switch, and the time constant is a product of the capacitance and a switch resistance.

3. The radiographic apparatus according to claim 1, wherein said AEC sensor is formed in a portion below said image forming sensor.

4. The radiographic apparatus according to claim 3, wherein said AEC sensor is formed across a plurality of areas of said image forming sensors.

5. The radiographic apparatus according to claim 1, wherein said AEC sensor is formed between pixels of said image forming sensor.

6. The radiographic apparatus according to claim 1, further comprising a radiation unit that irradiates the radiation,
wherein said AEC sensor measures a radiation dose of the radiation and performs exposure control based on the measured radiation dose.

7. The radiographic apparatus according to claim 1, wherein said image forming sensor is capable of being used for motion image sensing,
wherein, letting that a maximum frame rate per second be N and the time constant of said AEC sensor be RC, 5×RC≦0.1/N second is satisfied.
